(19) United States
(12) Patent Application Publication
(10) Pub. No.: US 2023/0158873 A1
(43) Pub. Date: May 25, 2023

(54) PRESSURE VARIABLE WEATHER STRIP CONTROL METHOD

(71) Applicants: Hyundai Motor Company, Seoul (KR); Kia Corporation, Seoul (KR)

(72) Inventors: Myung-Hee Lee, Seoul (KR); Hyun-Sung Nam, Seoul (KR); In-Ki Eom, Hwaseong-Si (KR); Dae-Hyun Yoon, Gwangmyeong-Si (KR)

(21) Appl. No.: 17/880,040

(22) Filed: Aug. 3, 2022

(30) Foreign Application Priority Data
Nov. 19, 2021 (KR) 10-2021-0160624

(51) Int. Cl. B60J 10/244

(52) U.S. Cl. CPC B60J 10/244; B60J 10/86

(57) ABSTRACT

A method of controlling a pressure variable weather strip for varying a pressure of a sealing part of the weather strip is provided. The method includes a closing checking step of, by a controller, checking whether an opening/closing part of a vehicle is in a closed state. When a vehicle speed reaches a preset target vehicle speed to increase the pressure of the sealing part in a state in which the opening/closing part is closed, the controller operates an air supply device to supply air to the sealing part.

### CROSS-REFERENCE TO RELATED APPLICATION

This application claims under 35 U.S.C. § 119(a) the benefit of Korean Patent Application No. 10-2021-0160624, filed on Nov. 19, 2021, the entire contents of which are incorporated herein by reference.

### BACKGROUND OF THE DISCLOSURE

### Field of the Disclosure

The present disclosure relates to a weather strip that seals a portion between an opening and closing part of a vehicle and a vehicle body and, more particularly, to a control method for a pressure variable weather strip to prevent an inflow of foreign substances or noise from the outside while facilitating the closing of a door by adjusting the internal pressure according to the situations.

### Description of Related Art

A weather strip may be mounted on an opening/closing part of a vehicle, such as a door, a trunk lid, a tailgate, a sunroof, or the like, to seal a portion between the opening/closing part and a vehicle body.

The weather strip may made of an elastic material such as synthetic rubber.

The weather strip may have a sealing part having a closed cross-section deformed to perform a sealing action.

When the door is closed, the sealing part may deform in cross-section and seal a portion between the door and the vehicle body.

When the internal pressure of the sealing part is low, for example, various noises such as driving noise, road noise, or the like are introduced during high-speed traveling of a vehicle. However, if the internal pressure of the sealing part is increased, the door may not easily close due to a reaction force upon closing of the door.

Therefore, there is a trade-off relationship between noise introduction and door closing according to the internal pressure of the sealing part, and it is not easy to improve this problem.

This problem occurs not only with the door, but also with other opening/closing parts in a vehicle, i.e., a trunk lid, a tailgate, a sunroof, etc., to which a weather strip is applied.

The contents described in Description of Related Art are to help the understanding of the background of the present disclosure, and may include what is not previously known to those skilled in the art to which the present disclosure pertains.

### SUMMARY OF THE DISCLOSURE

Therefore, an objective of the present disclosure is to provide a control method of a weather strip capable of being pressure variable to prevent noise introduction during high-speed driving, and to change a reaction force according to a vehicle driving condition so that the reaction force is reduced upon door closing.

According to an embodiment of the present disclosure, there may be a method of controlling a pressure variable weather strip for varying a pressure of a sealing part of the weather strip, the method including: a closing checking step of, by a controller, checking whether an opening/closing part of a vehicle is in a closed state, wherein when a vehicle speed reaches a preset target vehicle speed to increase the pressure of the sealing part in a state in which the opening/closing part is closed, the controller operates an air supply device to supply air to the sealing part.

In an embodiment, the method may include: after the closing checking step, a vehicle speed comparison step of comparing whether the vehicle speed input to the controller is equal to or greater than the target vehicle speed; a pump operating step of operating, by the controller, an air supply device to supply air into the sealing part when the vehicle speed is equal to or greater than the target vehicle speed; a first pressure comparison step of comparing, by the controller, whether the pressure of the sealing part is equal to or greater than a preset first target pressure; and a pump stopping step of stopping, by the controller, the operation of the air supply device when the pressure of the sealing part is equal to or greater than the first target pressure.

In an embodiment, in the first pressure comparison step, if the pressure of the sealing part is not equal to or greater than the preset first target pressure, the pump operating step may be repeatedly performed.

In an embodiment, in the vehicle speed comparison step, if the vehicle speed is not equal to or greater than the target vehicle speed, a first atmospheric pressure maintaining step of opening, by the controller, a control valve to discharge air of the sealing part so that the pressure of the sealing part is lowered may be performed.

In an embodiment, the first target pressure may be set to be higher than an atmospheric pressure.

In an embodiment, the first target pressure may be set to be higher as the vehicle speed increases.

In an embodiment, the method may further include: when the opening/closing part is in an open state in the closing checking step, a valve opening step of setting, by the controller, a second target pressure for lowering the pressure of the sealing part, operates the air supply device so that the pressure of the sealing part reaches the second target pressure, and at the same time, opens a direction-switching valve mounted between the air supply device and an atmospheric pressure port so that the air of the sealing part is discharged into the atmosphere; a second pressure comparison step of comparing, by the controller, whether the pressure of the sealing part is equal to or less than a preset second target pressure; and a valve closing step of closing, by the controller, the direction-switching valve when the pressure of the sealing part is equal to or less than the second target pressure.

In an embodiment, in the valve opening step, in a state in which an air line from the air supply device to a portion where the atmospheric pressure port is formed is formed with an outlet air line, through which air is discharged from the air supply device, and an inlet air line, through which air is introduced from the sealing part to the air supply device, and the direction-switching valve mounted in the outlet air line may be operated to allow the outlet air line to communicate with the air supply device and the atmosphere, the air supply device may be operated so that the air of the sealing part is forcedly discharged into the atmosphere.

In an embodiment, in the second pressure comparison step, when the pressure of the sealing part is not equal to or less than the preset second target pressure, the valve opening step may be repeatedly performed by the controller.

In an embodiment, the second target pressure may be set to be lower than an atmospheric pressure.

In an embodiment, the method may further include: when the opening/closing part is in an open state in the closing checking step, a second atmospheric pressure maintaining step of opening, by the controller, a control valve to discharge air from the sealing part so that the pressure of the sealing part is lowered.

In an embodiment, the opening/closing part may be any one of a door, a trunk lid, a tailgate, and a sunroof.

In an embodiment, the target vehicle speed may be set differently when the opening/closing part is different.

In an embodiment, the air supply device may be any one of an air pump, a blower, an air compressor, and an air tank.

According to the pressure variable weather strip control method having the above configuration, when the external pressure is lowered due to an increase in vehicle speed, the pressure of the sealing part of the weather strip is increased so that the sealing force between the opening and closing part and the vehicle body is improved, thereby blocking the introduction of external noise.

In addition, upon the opening/closing of the opening/closing part, the pressure of the sealing part is lowered so that the opening and closing properties of the opening/closing part are improved.

### BRIEF DESCRIPTION OF THE DRAWINGS

FIG. 1 is a cross-sectional view illustrating a weather strip according to the related art;

FIG. 2 is a schematic diagram illustrating a control system of a pressure variable weather strip according to an embodiment of the present disclosure;

FIG. 3 is a schematic diagram illustrating a control system of a pressure variable weather strip according to another embodiment of the present disclosure;

FIG. 4 is a flowchart illustrating a control method of a pressure variable weather strip according to an embodiment of the present disclosure;

FIG. 5 is a flowchart illustrating a control method of a pressure variable weather strip according to another embodiment of the present disclosure; and

FIG. 6 is a flowchart illustrating a control method of a pressure variable weather strip according to still another embodiment of the present disclosure.

### DESCRIPTION OF SPECIFIC EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although an embodiment may be described as using a plurality of units to perform a process, it is understood that processes may also be performed by one or a plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, a method for controlling a pressure variable weather strip according to the present disclosure will be described in detail with reference to the accompanying drawings.

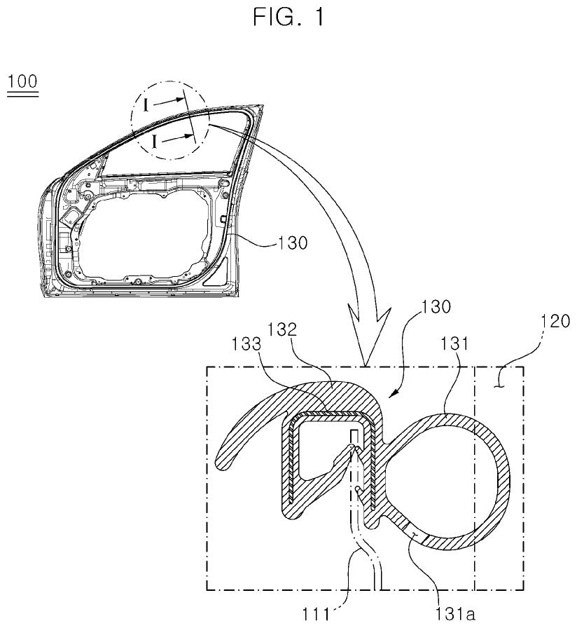

A weather strip may be mounted on an opening/closing part of a vehicle, such as a door, a trunk lid, a tailgate, a sunroof, or the like, to seal a portion between the opening/closing part and a vehicle body. For example, as illustrated in FIG. 1, a weather strip 130 is mounted on a vehicle door 110 to seal a portion between the door 110 and a vehicle body 120.

The weather strip 130 may be made of an elastic material such as synthetic rubber.

As illustrated in FIG. 1, the weather strip has a sealing part 131 having a closed cross-section deformed to perform a sealing action, a fixing part 132 that allows the weather strip 130 to be fixed to a door panel 111 of the door 110, and an insert 133 that is inserted into the fixing part 132 to provide rigidity so that the fixing part 132 is not separated from the door panel 111.

In the weather strip 130, when the door 110 is closed, the sealing part 131 deforms in cross-section and seals a portion between the door 110 and the vehicle body 120.

When the internal pressure of the sealing part 131 is low, various noises such as driving noise, road noise, or the like are introduced during high-speed traveling of a vehicle. To prevent this, if the internal pressure of the sealing part 131 is increased, the door 110 is not easily closed due to a reaction force upon closing of the door 110.

Therefore, in the weather strip 130, since there is a trade-off relationship between noise introduction and door closing according to the internal pressure of the sealing part 131, it is not easy to improve this problem.

In order to solve this problem, a through hole 131a is formed in the sealing part 131 or a variable cross-section is applied to a portion of the weather strip 130, but the above-mentioned problem is not completely solved, and it is difficult to keep the quality of the weather strip 130 consistent.

This problem is also applied not only to the door 110, but also to other opening/closing parts in a vehicle, i.e., a trunk lid, a tailgate, a sunroof, etc., to which the weather strip 130 is applied.

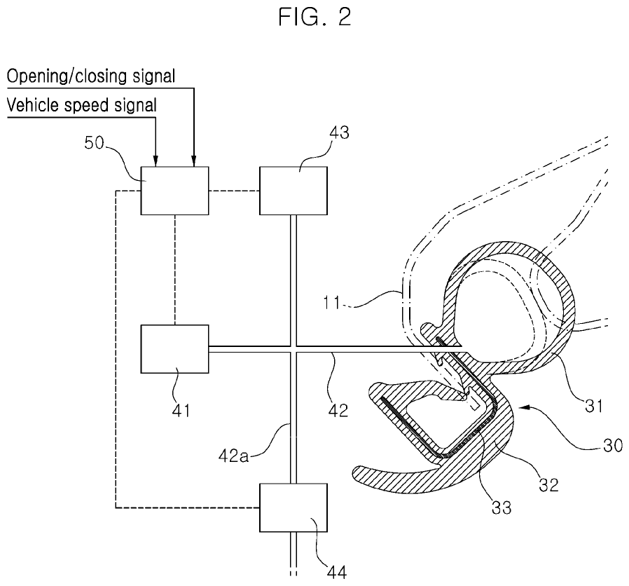

FIG. 2 illustrates a control system for performing the control method of the pressure variable weather strip according to the present disclosure.

The weather strip 30 is mounted on the opening/closing part 10 of a vehicle to seal a portion between the opening/closing part 10 and a vehicle body 20. The opening/closing part 10 may be a vehicle door, a trunk lid, a tailgate, a sunroof, etc., and a description will hereinafter be made of the case where the weather strip is mounted on the vehicle door 10.

The weather strip 30 may include a sealing part 31 having a hollow interior, a fixing part 32 integrally formed with the sealing part 31 so as to be fixed to the door 10, and an insert 33 inserted into the interior of the fixing part 32 to provide rigidity to the fixing part 32.

The air supply device 41 pressurizes and discharges air. The air discharged from the air supply device 41 may be supplied to the sealing part 31.

The air supply device 41 may be applied with an air pump that pressurizes and discharges air, a blower that supplies and discharges air at a high speed, an air compressor that compresses air, an air tank in which pressurized air is stored, etc. Hereinafter, a case in which the air pump 41 may be applied as the air supply device 41 will be described as an example, but the air supply device 41 is not limited to the air pump 41.

An air line 42 connects the air supply device 41, that is, the air pump 41, and the sealing part 31 of the weather strip 30. Air discharged from the air pump 41 may be supplied to the sealing part 31 through the air line 42. The air line 42 may be provided with an atmospheric pressure port 42a that communicates with an external environment.

A pressure sensor 43 may be mounted on one side of the air line 42 to measure and output the pressure of the sealing part 31.

A control valve 44 may be provided to allow the air in the sealing part 31 to be discharged to the outside. The control valve 44 may be mounted in the atmospheric pressure port 42a branched from the air line 42 to allow the air line 42 and the outside to communicate with or be blocked from each other.

The controller 50 may be configured to receive opening/closing signals from the opening/closing part 10, a vehicle speed, and a pressure of the sealing part 31 measured by the pressure sensor 43. The controller 50 may be configured to control the air pump 41 and the control valve 44 on the basis of this input. The controller 50 may be configured to store a control method of the pressure variable weather strip to be described later as a logic, so that the pressure of the sealing part 31 may be controlled according to conditions such as an opening/closing state of the opening/closing part 10, the vehicle speed, or the like.

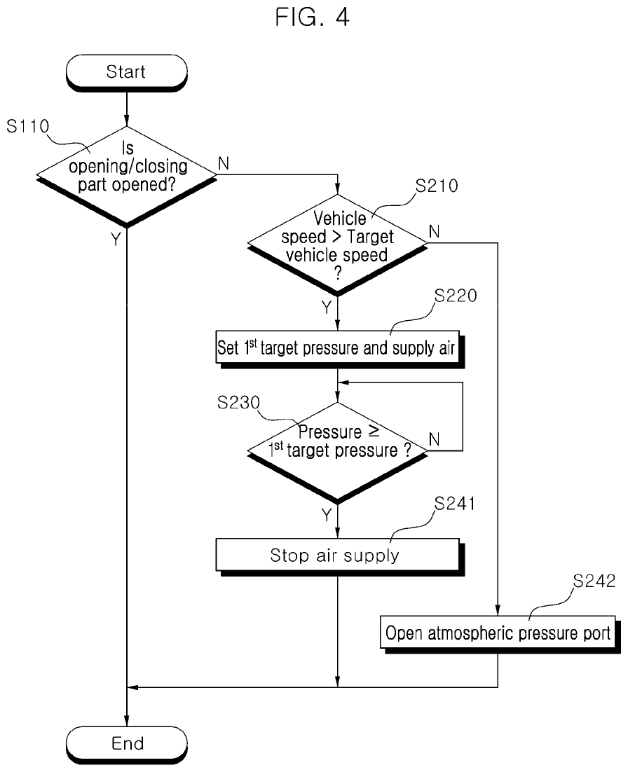

FIG. 4 illustrates a control method of a pressure variable weather strip according to an embodiment of the present disclosure using the control system of FIG. 2. The control method of the pressure variable weather strip according to the present disclosure, with which the pressure of a sealing part 31 of a weather strip 30 is varied, may include a step S110 of, by a controller 50, checking whether an opening/closing part 10 of a vehicle is in a closed state, wherein if the opening/closing part 10 is in the closed state, when a vehicle speed reaches a preset target speed to increase the pressure of the sealing part 31, the controller 50 may be configured to operate an air supply device 41 to supply air to the sealing part 31.

In the closing state-checking step S110, the controller 50 may be configured to check whether the opening/closing part 10 of a vehicle is in a closed state. The controller 50 may be configured to check whether the opening/closing part 10, e.g., the door 10, is in the closed state, when an operation signal of a door lock or a signal from an ajar switch is received. This is the same as in a trunk lid, a tailgate, a sunroof, or the like.

In a vehicle speed comparison step S210, the controller 50 may be configured to perform a comparison to check whether a vehicle speed input to the controller 50 is equal to or greater than a target vehicle speed preset to increase the pressure of the sealing part 31. The vehicle speed comparison step S210 may be performed to increase the pressure of the sealing part 31 when the opening/closing part 10, for example the door 10, is closed.

The target vehicle speed may be set differently when the opening/closing part 10 is changed. That is, the target vehicle speed may be set differently for the door 10, the trunk lid, the tailgate, and the sunroof.

In a pump operating step S220, when the vehicle speed is equal to or greater than the target vehicle speed, the controller 50 may be configured to operate the air pump 41 to supply air into the sealing part 31. By closing the control valve 44 together with the operation of the air pump 41, the air discharged from the air pump 41 may be supplied to the sealing part 31 through the air line 42 to increase the pressure of the sealing part 31. As the pressure of the sealing part 31 increases, a sealing force between the door 10 and the vehicle body increases, thereby blocking noise from being introduced into a vehicle interior from the outside.

In a first pressure comparison step S230, the controller 50 may be configured to perform a comparison to check whether the pressure of the sealing part 31 is equal to or greater than a preset first target pressure.

If the pressure of the sealing part 31 is equal to or greater than the first target pressure in the first pressure comparison step S230, a pump stopping step S241 to be described later may be performed, and if the pressure of the sealing part 31 is not equal to or greater than the first target pressure, the pump operating step S220 is repeatedly performed.

Here, the first target pressure may preferably be set higher than an atmospheric pressure. As the first target pressure is set higher than the atmospheric pressure, the pressure of the sealing part 31 is increased during high-speed driving of a vehicle to improve the sealing force between the door 10 and the vehicle body, thereby blocking the introduction of external noise.

Also, the first target pressure may be set to increase as the vehicle speed increases. For example, the first target pressure may be set to have a positive correlation with the vehicle speed. Alternatively, as the first target pressure increases every 20 KPH, the first target pressure may be set in a step manner such that the first target pressure increases at each specific speed.

In addition, the first target pressure may be set differently according to the opening/closing part 10. That is, the first target pressure may be set differently for the door 10, the trunk lid, the tailgate, or the sunroof.

In the pump stopping step S241, when the pressure of the sealing part 31 is equal to or greater than the first target pressure, the controller 50 may be configured to stop the operation of the air pump 41. At this time, the control valve 44 maintains a closed state. As the operation of the air pump 41 is stopped, the pressure in the sealing part 31 may not be increased, but, for example, maintained.

Meanwhile, if the vehicle speed is equal to or greater than the target vehicle speed in the vehicle speed comparison step S210, the pump operating step S220 may be performed, but if the vehicle speed is not equal to or greater than the target vehicle speed, that is, if the vehicle speed is less than the target vehicle speed, a first atmospheric pressure maintaining step S242 may be performed in which the control valve 44 may be opened by the controller 50 so that the pressure of the sealing part 31 is lowered.

When the pressure of the sealing part 31 is higher than atmospheric pressure, upon the opening of the opening/closing part 10, the sealing part 31 may be separated from the vehicle body, thereby inhibiting the feeling of openness due to noise or adhesive force. To prevent this, when a vehicle travels at a speed lower than the target vehicle speed, the atmospheric pressure port 42a may be maintained in an open state. When the pressure of the sealing part 31 is lowered to the atmospheric pressure level, noise or adhesive force generated when the sealing part 31 is separated from the vehicle body may be suppressed, and the feeling of openness is improved.

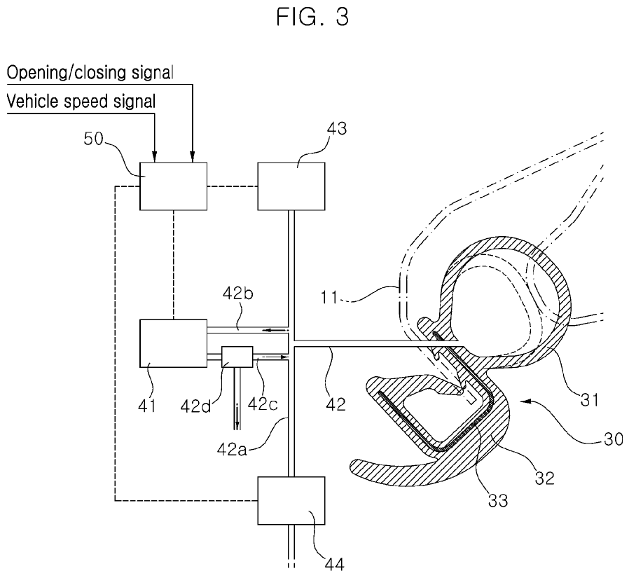

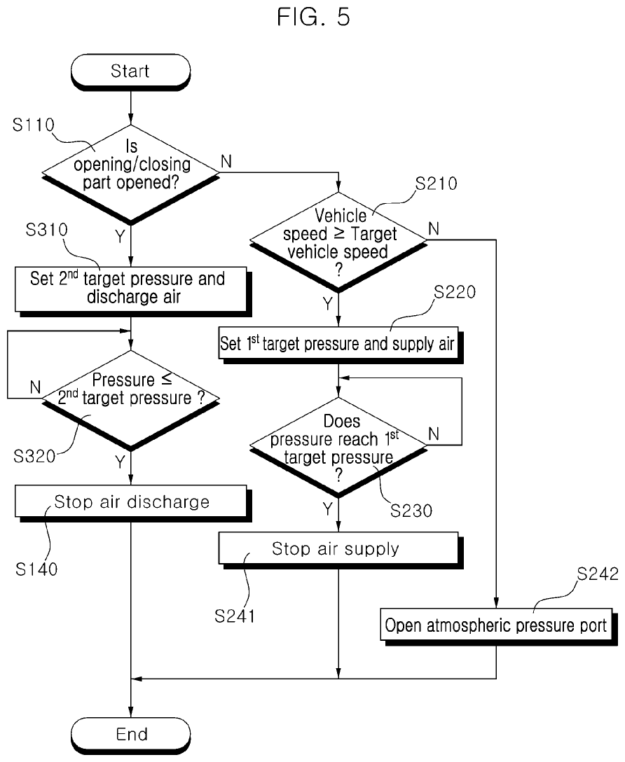

FIG. 5 illustrates another embodiment of a control method of a pressure variable weather strip according to the present disclosure. This embodiment may be performed by the control system of FIG. 3.

In this embodiment, in the closing checking step S110, since the operation in the closed state of the opening/closing part 10 is the same as that of the previously described embodiment in reference to FIG. 4, a detailed description thereof will be omitted, and a control process in the open state of the opening/closing part 10 will be explained.

In the closing checking step S110, when it is checked that the opening/closing part 10 is in an open state, the pressure of the sealing part 31 may be lowered to an atmospheric pressure level in advance to reduce a reaction force of the sealing part 31 so as to facilitate the closing of the opening/closing part 10.

In a valve opening step S310, the controller 50 may be configured to set a second target pressure for lowering the pressure of the sealing part 31, may be configured to operate a direction-switching valve 42d such that the pressure of the sealing part 31 reaches the second target pressure, and may be configured to operate the air pump 41.

In the control system as illustrated in FIG. 3, an inlet air line 42b, through which air may be introduced into the air pump 41, and an outlet air line 42c, through which air may be discharged from the air pump 41, may form a part of the air line 42. That is, a portion from the air pump 41 to the atmospheric pressure port 42a may be provided with the outlet air line 42c through which air is discharged from the air pump 41, and the inlet air line 42b through which air is introduced from the sealing part 31 into the air pump 41. If necessary, the inlet air line 42b and the outlet air line 42c may be provided with a configuration (e.g., a check valve, etc.) for allowing the air to flow in one direction. The outlet air line 42c may be provided with the direction-switching valve 42d for supplying the air discharged from the air pump 41 to the sealing part 31 or discharging the same into the atmosphere.

In the valve opening step S310, when the air pump 41 operates in a state in which the direction-switching valve 42d may be operated to allow the air pump 41 to communicate with the atmosphere, the air in the sealing part 31 may be forcedly discharged into the atmosphere.

After being introduced into the air pump 41 through the inlet air line 42b, the air in the sealing part 31 may be forcedly discharged into the atmosphere through the outlet air line 42c and the direction-switching valve 42d. The second target pressure may preferably be set to be lower than an atmospheric pressure. With forced discharging into the atmosphere as described above, the pressure of the sealing part 31 may be maintained lower than an atmospheric pressure.

In a second pressure comparison step S320, the controller 50 may be configured to perform a comparison to check whether the pressure of the sealing part 31 is equal to or less than a preset second target pressure. In the second pressure comparison step S320, if the pressure of the sealing part 31 is equal to or less than the second target pressure, a valve closing step S330 to be described later may be performed, and if the pressure of the sealing part 31 exceeds the second target pressure, the valve opening step S310 may be repeatedly performed.

In a valve closing step S330, when the pressure of the sealing part 31 is equal to or less than the second target pressure, the controller 50 may be configured to close the direction-switching valve 42d. By closing the direction-switching valve 42d, the pressure of the sealing part 31 may be maintained below the second target pressure.

In this state, when the opening/closing part 10 is closed, a reaction force of the sealing part 31 may be reduced, thereby improving the closing property. In addition, when the opening/closing part 10 is reopened, the openness of the opening/closing part 10 may be also improved.

While the valve opening step S310 to the valve closing step S330 are performed, the control valve 44 is closed.

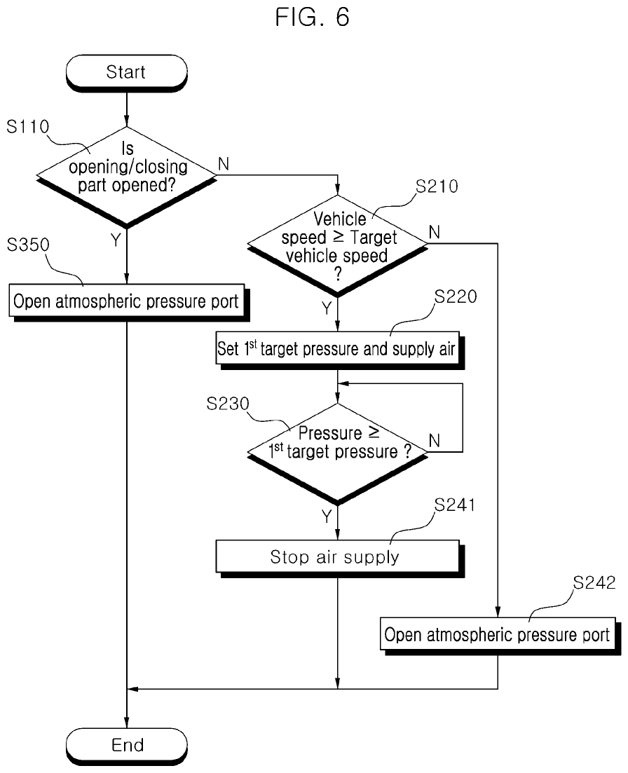

FIG. 6 illustrates a control method of a pressure variable weather strip according to another embodiment. This embodiment may be performed by the control system of FIG. 2.

In this embodiment, when the opening/closing part 10 is sensed as being in an open state in the closing checking step S110, a second atmospheric pressure maintaining step S350 may be performed in which the control valve 44 may be opened so that the pressure of the sealing part 31 is lowered to an atmospheric pressure level.

When the opening/closing part 10 is detected as being in a closed state in the closing checking step S110, the vehicle speed comparison step S210 to the first atmospheric pressure maintaining step S242 may be performed in the same manner as in the above-described embodiment in reference to FIGS. 4 and/or 5.

When the opening/closing part 10 is detected as being in an open state in the closing checking step S110, the second atmospheric pressure maintaining step S350 may be performed.

In the second atmospheric pressure maintaining step S350, the controller 50 may be configured to open the control valve 44 to maintain the pressure of the sealing part 31 at an atmospheric pressure. Since the pressure of the sealing part 31 is maintained at the atmospheric pressure, upon the closing of the opening/closing part 10, the reaction force of the sealing part 31 may be reduced, so that the closing property of the opening/closing part 10 may be improved.

What is claimed is:

1. A method of controlling a pressure variable weather strip, the method comprising:
a closing checking step of, by a controller, checking whether an opening/closing part of a vehicle is in a closed state; and
when a vehicle speed input into the controller reaches a preset target vehicle speed, operating, by the controller, an air supply device to supply air to a sealing part of a pressure variable weather strip to increase a pressure of the sealing part when the opening/closing part is in a closed state.

2. The method of claim 1, comprising: after the closing checking step, a vehicle speed comparison step of comparing whether the vehicle speed input to the controller is equal to or greater than the target vehicle speed;
a pump operating step of supplying air, by the controller operating an air supply device, into the sealing part when the vehicle speed is equal to or greater than the target vehicle speed;
a first pressure comparison step of comparing, by the controller, whether the pressure of the sealing part is equal to or greater than a preset first target pressure; and
a pump stopping step of stopping, the supply of air by the controller operating the air supply device, when the pressure of the sealing part is equal to or greater than the first target pressure.

3. The method of claim 2, further comprising: if, in the first pressure comparison step, the pressure of the sealing part is not equal to or greater than the preset first target pressure, repeatedly performing the pump operating step by the controller.

4. The method of claim 2, further comprising: if, in the vehicle speed comparison step, the vehicle speed is not equal to or greater than the target vehicle speed, a first atmospheric pressure maintaining step of opening, by the controller, a control valve to discharge air of the sealing part so that the pressure of the sealing part is lowered.

5. The method of claim 2, wherein the first target pressure is set to be higher than an atmospheric pressure.

6. The method of claim 2, wherein the first target pressure is set to increase as the vehicle speed increases.

7. The method of claim 1, further comprising: when the opening/closing part is in an open state in the closing checking step,
a valve opening step of setting, by the controller, a second target pressure for lowering the pressure of the sealing part, operating, by the controller, the air supply device so that the pressure of the sealing part reaches the second target pressure, and opening, by the controller, a direction-switching valve mounted between the air supply device and an atmospheric pressure port so that the air of the sealing part is discharged;
a second pressure comparison step of comparing, by the controller, whether the pressure of the sealing part is equal to or less than a preset second target pressure; and
a valve closing step of closing, by the controller, the direction-switching valve when the pressure of the sealing part is equal to or less than the second target pressure.

8. The method of claim 7, wherein an air line from the air supply device to a portion where the atmospheric pressure port is formed with an outlet air line, through which air is discharged from the air supply device, and an inlet air line, through which air is introduced from the sealing part to the air supply device, and the direction-switching valve mounted in the outlet air line is operated to allow the outlet air line to discharge air through the atmospheric pressure port, the air supply device is operated, in the valve opening step, so that the air of the sealing part is forcedly discharged.

9. The method of claim 7, further comprising: if, in the second pressure comparison step the pressure of the sealing part is not equal to or less than the preset second target pressure, repeatedly performing the valve opening step by the controller.

10. The method of claim 7, wherein the second target pressure is set to be lower than an atmospheric pressure.

11. The method of claim 1, further comprising: when, in the closing checking step, the opening/closing part is in an open state,
a second atmospheric pressure maintaining step of opening, by the controller, a control valve to discharge air from the sealing part so that the pressure of the sealing part is lowered.

12. The method of claim 1, wherein the opening/closing part is any one of a door, a trunk lid, a tailgate, and a sunroof.

13. The method of claim 12, wherein the target vehicle speed is set differently when the opening/closing part is different.

14. The method of claim 1, wherein the air supply device is any one of an air pump, a blower, an air compressor, and an air tank.
